(19) United States
(12) Patent Application Publication
(10) Pub. No.: US 2023/0295377 A1
(43) Pub. Date: Sep. 21, 2023

(54) AQUEOUS POLYAMIDE-AMIC ACID COMPOSITIONS, PROCESS FOR FORMING SAID COMPOSITIONS, AND USES THEREOF

(71) Applicant: Cytec Industries, Inc., Princeton, NJ (US)

(72) Inventors: Alan Thomas, Mauldin, SC (US); James Joe Evans, Piedmont, SC (US); William R. Tilford, Stone Mountain, GA (US); Nan Chen, Cumming, GA (US)

(73) Assignee: Cytec Industries Inc., Princeton, NJ (US)

(21) Appl. No.: 18/006,315

(22) PCT Filed: Jul. 20, 2021
(86) PCT No.: PCT/US2021/042277

§ 371 Date: Jan. 20, 2023

Related U.S. Application Data
(60) Provisional application No. 63/054,939, filed on Jul. 22, 2020.

(51) Int. Cl. C08G 73/10; C08J 7/04; C08J 5/06

(52) U.S. Cl. CPC C08G 73/1032; C08J 7/0427; C08J 5/06; C08J 2379/08

(57) ABSTRACT

The present disclosure relates to aqueous compositions containing water and the ammonium salt of a polyamide-amic acid. Processes for producing such aqueous compositions and uses thereof are described.

### CROSS REFERENCE TO RELATED APPLICATIONS

This present application claims priority to U.S. provisional application No. 63/054,939, filed Jul. 22, 2020, the entire contents of which is hereby incorporated by reference.

### FIELD OF THE INVENTION

The present invention relates to the field of aqueous compositions containing polyamide-amic acid suitable for use in coating applications, processes for producing said aqueous compositions, and uses thereof.

### BACKGROUND

Polyamide-amic acids are precursors to polyamide-imides, which have excellent high temperature stability properties, and are useful in coating applications. Formulations containing polyamide-amic acids may be used for coating and sizing fibers, metal surfaces, glass surfaces and other materials. However, because polyamide-imide polymers are intractable and substantially insoluble, coating and sizing formulations are generally applied to the work as an amide-amic acid polymer precursor. The polyamide-amic acid resin coating or matrix is then cured thermally, generally at a temperature above about 150° C., forming a polyamide-imide resin.

Polyamide-amic acid resins, typically aromatic polyamide-amic acid resins, are generally available in dry solid form. However, these compositions are neither soluble nor readily dispersible in solvents considered environmentally acceptable, such as water. High temperature dipole solvents have been used to disperse the polyamides, but are known to be difficult to remove on forming the coating and fiber sizing. U.S. Pat. No. 6,479,581 B1 discloses the use of water-soluble tertiary amine in stoichiometric excess to drive the equilibrium in the direction of forming water-soluble amine salts. However, formation of such salts are difficult and requires a significant excess of tertiary amine to obtain suitable dispersions. The use of polyamide-amic acid compositions made in this manner to size fibers, such as carbon fiber, requires multiple insertions or dips as well as a multistep and lengthy drying process to dry the amine salt before it can be cured at high temperature to form the polyamide-imide coating. A high temperature heating process is required to remove the tertiary amines from the coating or sizing, which may lead to hydrolysis or otherwise detrimentally impact the resin.

Thus, there is an ongoing need for new or improved methods for forming aqueous solutions or dispersions of polyamide-amic acids that can be easily applied to a substrate, as well as dried and cured with minimal risk of damaging the coating.

### SUMMARY OF THE INVENTION

This objective, and others which will become apparent from the following detailed description, are met, in whole or in part, by the compositions, methods and/or processes of the present disclosure.

In a first aspect, the present disclosure relates to an aqueous polyamide-amic acid composition, comprising:
water; and
a polyamide-amic acid comprising recurring units each having at least one aromatic ring and at least one of an amic acid group and an imide group, wherein, in more than 50% mol of said recurring units that comprise at least one amic acid group, all or part of the amic acid groups are in salified form in which the cation is an ammonium cation.

In a second aspect, the present disclosure relates to a process for forming the aqueous polyamide-amic acid composition described herein, the process comprising:
reacting, in an aqueous medium, a polyamide-amic acid comprising recurring units each having at least one aromatic ring and at least one of an amic acid group and an imide group with an ammonium salt.

In a third aspect, the present disclosure relates to a method for providing an adherent polyamide-imide film to at least one surface of a substrate, the method comprising:
coating the said surface with the aqueous polyamide-amic acid composition described herein,
heating the wet coating at a first temperature, thereby providing a dried coating comprising the polyamide-amic acid free of ammonium cation,
heating the said article at a second temperature to cure the dried coating, thereby providing the adherent polyamide-imide film on the at least one surface.

In a fourth aspect, the present disclosure relates to a film comprising the ammonium salt of a polyamide-amic acid, said film prepared from the aqueous polyamide-amic acid composition described herein.

In a fifth aspect, the present disclosure relates to an article of manufacture or one or more fibers comprising the film described herein.

In a sixth aspect, the present disclosure relates to a composite material comprising the one or more fibers described herein and a matrix resin.

### BRIEF DESCRIPTION OF THE DRAWINGS

FIG. 1 shows the TGA weight loss of a polyamide-amic acid wet-cake during heating.

### DETAILED DESCRIPTION

As used herein, the terms “a”, “an”, or “the” means “one or more” or “at least one” and may be used interchangeably, unless otherwise stated. As used herein, the term “comprises” includes “consists essentially of” and “consists of.” The term “comprising” includes “consisting essentially of” and “consisting of.”

Unless defined otherwise, all technical and scientific terms used herein have the same meaning as is commonly understood by one of skill in the art to which this specification pertains.

As used herein, and unless otherwise indicated, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 50%, 20%, 15%, 10%, 9%, 8%, 7%, 6%, 5%, 4%, 3%, 2%, 1%, 0.5%, or 0.05% of a given value or range.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

Throughout the present disclosure, various publications may be incorporated by reference. Should the meaning of any language in such publications incorporated by reference conflict with the meaning of the language of the present disclosure, the meaning of the language of the present disclosure shall take precedence, unless otherwise indicated.

In the first aspect, the present disclosure relates to an aqueous polyamide-amic acid composition, comprising:
water; and
a polyamide-amic acid comprising recurring units each having at least one aromatic ring and at least one of an amic acid group and an imide group, wherein, in more than 50% mol of said recurring units that comprise at least one amic acid group, all or part of the amic acid groups are in salified form in which the cation is an ammonium cation.

The polyamide-amic acid suitable for use in accordance with the present disclosure comprises recurring units each having at least one aromatic ring and at least one of an amic acid group and an imide group. In an embodiment, the polyamide-amic acid comprises recurring units each having at least one aromatic ring and at least one amic acid group. In another embodiment, the polyamide-amic comprises recurring units each having at least one aromatic ring and at least one imide group. In yet another embodiment, the polyamide-amic acid comprises recurring units each having at least one aromatic ring, at least one amic acid group, and at least one imide group.

In more than 50% mol of the recurring units that comprise at least one amic acid group, all or part of the amic acid groups are in salified, or salt, form in which the cation is an ammonium cation (NH₄⁺). In an embodiment, more than 60% mol, typically 80% mol, more typically 90% mol, of the recurring units that comprise at least one amic acid group, all or part of the amic acid groups are in salified form.

In an embodiment, the recurring units are each selected from the group consisting of:

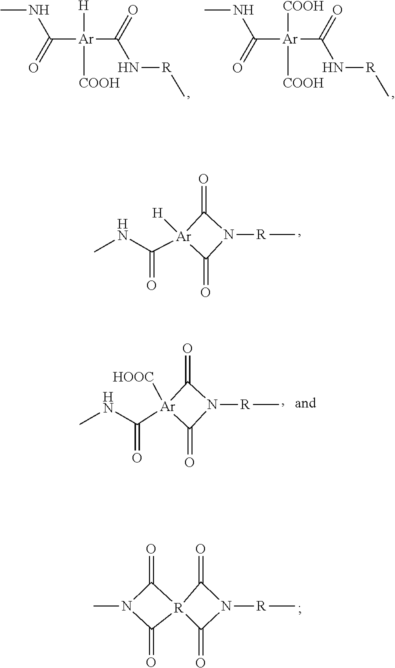

wherein
Ar is

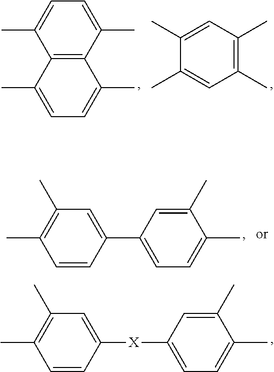

wherein X is

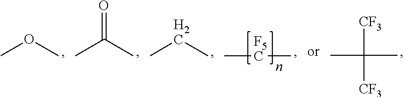

wherein n is 0, 1, 2, 3, 4, or 5;
R is

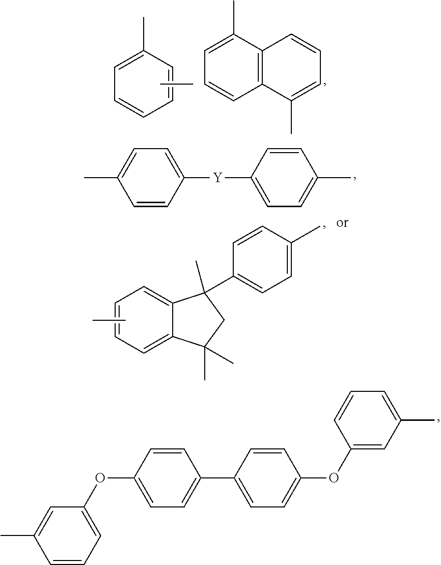

wherein Y is

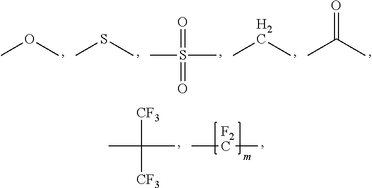

wherein m is 0, 1, 2, 3, 4, or 5.

In another embodiment, the recurring units are each selected from the group consisting of:

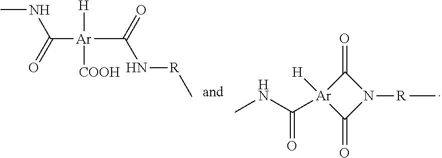

In an embodiment, Ar is

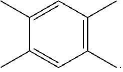

In an embodiment, R is

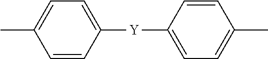

and Y is as defined herein.

The polyamide-amic acid may be characterized by a number average molecular weight (Mn) and is at least 1000, typically at least 1500, more typically at least 2000. The number average molecular weight is at most 20000, typically at most 15000, more typically at most 10000.

The polyamide-amic acid may be characterized by inherent viscosity, which may be at least 0.1, typically at least 0.15, more typically at least 0.2 dl/g when measured as a 0.5% wt solution in N,N-dimethylacetamide at 30° C.

The polyamide-amic acid may be obtained from commercial sources or manufactured according to methods known to those of ordinary skill in the art. For example, the polyamide-amic acid may be made by the polycondensation reaction of at least one acid monomer selected from the group consisting of pyromellitic anhydride, bis(3,4-dicarboxyphenyl)ether dianhydride, trimellitic anhydride and trimellitic anhydride monoacid halides, with at least one comonomer selected from the group consisting of diamines and diisocyanates.

In an embodiment, the at least one acid monomer is selected from the group consisting of pyromellitic anhydride, bis(3,4-dicarboxyphenyl)ether dianhydride, trimellitic anhydride and trimellitic anhydride monoacid halides. In another embodiment, the at least one acid monomer is trimellitic anhydride monoacid chloride.

The comonomer typically comprises at least one aromatic ring and at most two aromatic rings. In an embodiment, the comonomer is a diamine, typically selected from the group consisting of 4,4′-diaminodiphenylmethane, 4,4′-diaminodiphenylether, m-phenylenediamine, para-phenylenediamine, 4,4′-diaminodiphenylsulfone, 4,4′-diaminodiphenylsulfide, and mixtures thereof.

The polycondensation reaction is carried out under substantially anhydrous conditions in a polar solvent and at a temperature below 150° C., employing substantially stoichiometric quantities of the acid monomer and of the comonomer. A slight stoichiometric excess, usually from about 0.5 to about 5 mole %, of either monomer, typically of the acid monomer, can be employed if desired in order to control molecular weight; alternatively a monofunctional reactant can be employed as an endcapping agent for this purpose, and to improve stability.

In such a method, the polyamide-amic acid is isolated in solid form under mild conditions, typically by being coagulated or precipitated from the polar reaction solvent by adding a miscible non-solvent, such as water, a lower alkyl alcohol or the like. Optionally, the solid resin may then be collected and thoroughly washed with water, and centrifuged or pressed to further reduce the water content of the solid without applying heat. Non-solvents other than water and lower alkyl alcohols are known and may be used to precipitate the polyamide-amic acid from solution including, for example, ethers, aromatic hydrocarbons, ketones and the like. The washed and pressed polyamide-amic acid wetcake, isolated from the reaction mixture by precipitation and filtration, will be a solid, wet powder comprising as much as 80 wt. % water, typically from about 40 to about 70 wt. % water, based on combined weight of water and polymer. It may be desirable to minimize the water content of the resin wetcake by further pressing or similar conventional means to reduce the water content. However, it is essential that these processes be carried out without subjecting the resin to heat or other conditions which may imidize or cause a reduction in molecular weight, for example by hydrolysis. For most uses, including providing an aqueous solution of the polyamide-amic acid as further described herein below, the wetcake may be conveniently employed without further drying.

The aqueous polyamide-amic acid composition described herein may further comprising an organic solvent. As used herein, the term “organic solvent” refers to organic compounds that do not react with the amic acid group of the recurring units of the polyamide-amic acid polymers. Thus, the term “organic solvent” encompasses polar organic solvents able to dissolve the polyamide-amic acid itself or other organic liquids miscible with water. Exemplary organic solvents include, but are not limited to, N-methylpyrrolidone (NMP), N,N-dimethylformamide, N,N-dimethylacetamide, dimethylsulfoxide, cresylic acid, sulfolane, formamide, and combinations thereof.

In an embodiment, the total amount of the organic solvent is less than 20% by weight with respect to the weight of the polyamide-amic acid.

The aqueous polyamide-amic acid composition of the present disclosure is free of tertiary amines, typically tertiary alkylamines, and salts thereof.

Examples of tertiary amines that are excluded from the aqueous compositions disclosed herein include tri-(C1-C4alkyl)amines, such as, for example, trimethylamine, N,N-dimethylethylamine, N,N-dimethylpropylamine, triethylamine, tributylamine or the like; cyclic tertiary amines, tertiary alkanol amines, including N,N-dimethylethanolamine, diethyl-2-hydroxyethylamine and the like; aromatic amines, such as N,N-dimethylaniline, pyridine, and N-methylpyrrole; and polyfunctional amines, such as N,N′-dimethylpiperidine, N,N,N′N′-tetraalkyl-alkylene diamines, and poly-N-alkylated alkylene triamines.

The aqueous polyamide-amic acid composition comprises an amount of water sufficient to provide a polyamide-amic acid content of from about 0.5 to about 15 wt. %, based on the total weight of the composition.

Optionally, the aqueous composition may further comprise benefit agents typical of coating compositions, such as: (i) dispersion agents; (ii) pigments like carbon black, silicates, metal oxides and sulfides; (iii) additives such as coating auxiliant or flow promoters; (iv) inorganic fillers like carbon fibers, glass fibers, metal sulfates, such as BaSO₄, CaSO₄, SrSO₄, oxides such as Al₂O₃ and SiO₂, zeolites, mica, talcum, kaolin; (v) organic fillers, typically thermally stable polymers, like aromatic polycondensate; (vi) film hardener, like silicate compounds, such as metal silicate, e.g. aluminum silicate and metal oxides, such as titanium dioxide and aluminum oxide; (vii) adhesion promoters, like colloidal silica and a phosphate compound, such as metal phosphate, e.g. Zn, Mn or Fe phosphate.

In the second aspect, the present disclosure relates to process for forming the aqueous polyamide-amic acid composition described herein, the process comprising:

reacting, in an aqueous medium, the polyamide-amic acid comprising recurring units each having at least one aromatic ring and at least one of an amic acid group and an imide group with an ammonium salt.

The step of reacting the polyamide-amic acid comprising recurring units each having at least one aromatic ring and at least one of an amic acid group and an imide group with an ammonium salt may be accomplished using methods known to those of ordinary skill in the art. The reaction of the polyamide-amic acid with the ammonium salt involves an apparent replacement of the carboxylic acid proton (H⁺) on the amic acid groups with the ammonium cation of the ammonium salt. The reaction may be conveniently carried out in a single operation by adding the polyamide-amic acid, typically in solid form, to the requisite quantity of water containing the ammonium salt. However, any convenient method of combining the components may be employed. In a suitable method, the polyamide-amic acid in solid form may be added in increments to a stirred mixture of the ammonium salt and water, continuing the stirring until the polyamide-amic acid has been dissolved. In another suitable method, the basic compound can be added slowly to a stirred suspension of the polyamide-amic acid in water, with continued stirring until the solid dissolves. External cooling may be necessary initially as the reaction is initiated, with subsequent warming and stirring possibly desired to complete the reaction and dissolution of the polyamide-amic acid in a reasonable time period.

In some embodiments, the mixture of the polyamide-amic acid and the ammonium salt may be heated at a temperature of at least 40° C., typically of at least 45° C., more typically of at least 50° C.

In some instances, combining the polyamide-amic acid in solid form with an amount of a suitable ammonium salt effective to substantially form the corresponding salified polyamide-amic acid is typically sufficient to dissolve the polyamide-amic acid and there is no need for additional organic solvent or coalescing agent.

The amount of ammonium salt used is not particularly limited. However, the minimum amount of ammonium salt employed will be approximately the stoichiometric amount required to salify the amic acid groups in the polymer, and will typically be at least 0.8, more typically at least 0.9 mole for each mole of amic acid groups in the polyamide-amic acid.

The maximum amount of ammonium salt employed will be at most 5 moles, typically at most 4.5 moles, more typically at most 4.0 moles for each mole of amic acid groups in the polyamide-amic acid.

In an embodiment, more than 50% mol of said recurring units that comprise at least one amic acid group, all or part of the amic acid groups are converted to salified form in which the cation is an ammonium cation.

The ammonium salt used in the process described herein comprises an ammonium cation and an anion that is the conjugate base of a weak acid. As known to those of ordinary skill in the art, weak acids encompass compounds that partially dissociate at equilibrium in water, including water itself.

In an embodiment, the ammonium salt comprises an ammonium cation and an anion selected from the group consisting of hydroxide, oxalate, carbonate, bicarbonate, sulfite, hydrogen sulfite, sulfate, hydrogen sulfate, dihydrogen phosphate, hydrogen phosphate, phosphate, nitrite, carboxylate, such as acetate, propanoate, butanoate; perchlorate, chlorate, chlorite, and hypochlorite.

In another embodiment, the ammonium salt comprises an ammonium cation and an anion selected from the group consisting of hydroxide and bicarbonate, typically bicarbonate.

In a third aspect, the present disclosure relates to a method for providing an adherent polyamide-imide film to at least one surface of a substrate, the method comprising:

coating the said surface with the aqueous polyamide-amic acid composition described herein, heating the wet coating at a first temperature, thereby providing a dried coating comprising the polyamide-amic acid free of ammonium cation, heating the said article at a second temperature to cure the dried coating, thereby providing the adherent polyamide-imide film on the at least one surface.

Coating the surface of a substrate with the aqueous polyamide-amic acid composition described herein may be achieved using any suitable method known to those of ordinary skill in the art. For example, the aqueous polyamide-amic acid composition may be deposited by spin casting, spray coating, spin coating, gravure coating, curtain coating, dip coating, slot-die coating, ink jet printing, gravure printing, screen printing, brushing, electrodeposition, or other such conventional methods, on the surface of the substrate. The at least one surface may be partially or completely coated.

Suitable substrates may comprise various materials, which are not particularly limited. However, suitable materials include, but are not limited to, plastic, such as polyethers, polyesters such as polyethylene terephtalate (PET) or polybutylene terphtalate (PBT), polycarbonates such as bisphenol A polycarbonate, styrenic polymers such as poly(styrene-acrylonitrile) (SAN) or poly(acrylonitrile-butadiene-styrene) (ABS), poly(meth)acrylate such as polymethylmethacrylate (PMMA), polyamides, polysulfones such as polysulfone (PSU), polyethersulfone (PESU) or polyphenysulfone (PPSU), polyether ether ketone (PEEK), polyaryletherketone (PAEK), polypolyethylene (PE), polypropylene (PP), polyvinylchloride (PVC), polyvinylidene fluoride (PVDF), and polyurethane; metal, such as iron, cast iron, copper, brass, aluminum, titanium, gold, carbon steel (“C-steel”), stainless steel, and oxides and alloys thereof; materials containing multivalent metal cations, such as hydroxyapatite, calcium carbonate (amorphous, calcite, aragonite), calcium phosphate, calcium hydroxide, magnesium carbonate, and magnesium phosphate; silicate materials, such as quartz and glass; ceramics, such as earthenware, stoneware, and porcelain, and graphitic materials.

Heating the wet coating at a first temperature provides a dried coating comprising the polyamide-amic acid free of ammonium cation and may be achieved using any conventional methods known to those of ordinary skill in the art. For example, the coated substrate may be heated with or without reduced pressure, for example, in an oven. Without wishing to be bound to theory, it is believed that heating the wet coating to the first temperature results in the removal of the ammonium cation, in the form of ammonia evolution. The removal of the ammonium ion in the form of ammonia evolution reverts the material back to the original polyamide-amic acid. At the same time, any residual solvent, typically water, is removed. The first temperature is not particularly limited as long as the ammonium cation is removed in the form of ammonia and/or any residual solvent, typically water, is removed while imidization is avoided. However, a first temperature of less than 150° C., typically less than 120° C., is suitable. In this manner, a dried coating comprising the polyamide-amic acid free of ammonium cation is obtained, which is the polyamide-amic acid used to react with an ammonium salt to form the aqueous polyamide-amic acid composition.

Curing the dried coating to obtain the adherent polyamide-imide film is achieved by heating the said substrate at a second temperature, and may be achieved using any conventional methods known to those of ordinary skill in the art. For example, the coated substrate may be heated with or without reduced pressure, for example, in an oven. Curing results in the imidization of the polyamide-amic acid to form the polyimide-imide film. The second temperature is not particularly limited as long as it is sufficient to affect the imidization of the polyamide-amic acid to form the polyamide-imide film. However, a second temperature of greater than 150° C. is suitable. In an embodiment, the second temperature is from 180° C. to 290° C.

The curing process may optionally be conducted in the presence of a matrix resin.

In such an embodiment, the film can crosslink with the matrix or form a film in situ.

Due to the ease with which the imidization of the polyamide-amic acid to form the corresponding polyamide-imide film can be achieved, the curing step generally takes less than about 15 minutes, typically less than about 5 minutes, more typically less than about 2 minutes. In an embodiment, the curing step takes 1 to 2 minutes.

The drying and curing steps may also be conducted in one step. In such an embodiment, the substrate having a wet coating of the ammonium salt of the polyamide-amic acid may be subjected to heating wherein the first and second temperatures are the same. In this embodiment, the first and second temperatures are each greater than 150° C., typically from 180° C. to 290° C.

In the fourth aspect, the present disclosure relates to a film comprising the ammonium salt of a polyamide-amic acid, said film prepared from the aqueous polyamide-amic acid composition. The film is formed by coating the surface of a substrate with the aqueous polyamide-amic acid composition described herein and may be achieved using any suitable method known to those of ordinary skill in the art, such as those described herein. For example, the aqueous polyamide-amic acid composition may be deposited by spin casting, spray coating, spin coating, gravure coating, curtain coating, dip coating, slot-die coating, ink jet printing, gravure printing, screen printing, brushing, electrodeposition, or other such conventional methods.

Suitable substrates may be selected from those described herein.

In a fifth aspect, the present disclosure relates to an article of manufacture or one or more fibers comprising the film comprising the ammonium salt of a polyamide-amic acid described herein.

The film may be formed on articles of manufacture as well as fibers and may be further dried and/or cured by heat treatment. In an embodiment, one or more heat-treated fibers are formed by heating one or more fibers comprising the said film.

In a sixth aspect, the present disclosure relates to a composite material comprising the one or more heat-treated fibers formed by heating one or more fibers comprising the film, the film comprising the ammonium salt of a polyamide-amic acid described herein, and a matrix resin.

Composite materials may be made by molding a preform and infusing the preform with a thermosetting resin in a number of liquid-molding processes. Liquid-molding processes that may be used include, without limitation, vacuum-assisted resin transfer molding (VARTM), in which resin is infused into the preform using a vacuum-generated pressure differential. Another method is resin transfer molding (RTM), wherein resin is infused under pressure into the preform in a closed mold. A third method is resin film infusion (RFI), wherein a semi-solid resin is placed underneath or on top of the preform, appropriate tooling is located on the part, the part is bagged and then placed in an autoclave to melt and infuse the resin into the preform.

The matrix resin for impregnating or infusing the preforms described herein is a curable resin. “Curing” or “cure” with respect to the matrix resin refers to the hardening of the typically polymeric material by the chemical cross-linking of the polymer chains. The term “curable” in reference to the matrix resin means that the matrix resin is capable of being subjected to conditions which will render the matrix resin to a hardened or thermoset state. The matrix resin typically is a hardenable or thermoset resin containing one or more uncured thermoset resins. Suitable thermoset resins include, but are not limited to, epoxy resins, oxetanes, imides (such as polyimide or bismaleimide), vinyl ester resins, cyanate ester resins, isocyanate-modified epoxy resins, phenolic resins, furanic resins, benzoxazines, formaldehyde condensate resins (such as with urea, melamine or phenol), polyesters, acrylics, hybrids, blends and combinations thereof.

Suitable epoxy resins include glycidyl derivatives of aromatic diamine, aromatic mono primary amines, aminophenols, polyhydric phenols, polyhydric alcohols, polycarboxylic acids and non-glycidyl resins produced by peroxidation of olefinic double bonds. Examples of suitable epoxy resins include polyglycidyl ethers of the bisphenols, such as bisphenol A, bisphenol F, bisphenol S, bisphenol K and bisphenol Z; polyglycidyl ethers of cresol and phenol-based novolacs, glycidyl ethers of phenol-aldelyde adducts, glycidyl ethers of aliphatic dials, diglycidyl ether, diethylene glycol diglycidyl ether, aromatic epoxy resins, aliphatic polyglycidylethers, epoxidised olefins, brominated resins, aromatic glycidyl amines, heterocyclic glycidyl imidines and amides, glycidyl ethers, fluorinated epoxy resins, or combinations thereof.

Specific examples are tetraglycidyl derivatives of 4,4′-diaminodiphenylmethane (TGDDM), resorcinol diglycidyl ether, triglycidyl-p-aminophenol, triglycidyl-m-aminophenol, bromobisphenol F diglycidyl ether, tetraglycidyl derivatives of diaminodiphenylmethane, trihydroxyphenyl methane triglycidyl ether, polyglycidylether of phenol-formaldehyde novolac, polyglycidylether of o-cresol novolac or tetraglycidyl ether of tetraphenylethane.

Suitable oxetane compounds, which are compounds that comprise at least one oxetano group per molecule, include compounds such as, for example, 3-ethyl-3[[(3-ethyloxetane-3-yl)methoxy]methyl]oxetane, oxetane-3-methanol, 3,3-bis-(hydroxymethyl) oxetane, 3-butyl-3-methyl oxetane, 3-methyl-3-oxetanemethanol, 3,3-dipropyl oxetane, and 3-ethyl-3-(hydroxymethyl) oxetane.

The curable matrix resin may optionally comprise one or more additives such as curing agents, curing catalysts, co-monomers, rheology control agents, tackifiers, inorganic or organic fillers, thermoplastic and/or elastomeric polymers as toughening agents, stabilizers, inhibitors, pigments, dyes, flame retardants, reactive diluents, UV absorbers and other additives well known to those of ordinary skill in the art for modifying the properties of the matrix resin before and/or after curing.

Examples of suitable curing agents include, but are not limited to, aromatic, aliphatic and alicyclic amines, or guanidine derivatives. Suitable aromatic amines include 4,4′-diaminodiphenyl sulphone (4,4′-DDS), and 3,3′diaminodiphenyl sulphone (3,3-DDS), 1,3-diaminobenzene, 1,4-diaminobenzene, 4,4′-diammodiphenylmethane, benzenediamine(BDA); Suitable aliphatic amines include ethylenediamine (EDA), 4,4′-methylenebis(2,6-diethylaniline) (M-DEA), m-xylenediamine (mXDA), diethylenetriamine (DETA), triethylenetetramine (TETA), trioxatridecanediamine (TTDA), polyoxypropylene diamine, and further homologues, alicyclic amines such as diaminocyclohexane (DACH), isophoronediamine (IPDA), 4,4′ diamino dicyclohexyl methane (PACM), bisaminopropylpiperazine (BAPP), N-aminoethylpiperazine (N-AEP); Other suitable curing agents also include anhydrides, typically polycarboxylic anhydrides, such as nadic anhydride, methylnadic anhydride, phthalic anhydride, tetrahydrophthalic anhydride, hexahydrophthalic anhydride, methyltetrahydrophthalic anhydride, methylhexahydrophthalic anhydride, endomethylene-tetrahydrophtalic anhydride, pyromellitic dianhydride, chloroendic anliydride and trimellitic anhydride.

Still other curing agents are Lewis acid:Lewis base complexes. Suitable Lewis acid:Lewis base complexes include, for example, complexes of: BCl₃:amine complexes, BF₃:amine complexes, such as BF₃:monoethylamine, BF₃:propylamine, BF₃:isopropyl amine, BF₃:benzyl amine, BF₃:chlorobenzyl amine, BF₃:trimethylamine, BF₃:pyridine, BF₃:THF, AlCl₃:THF, AlCl₃:acetonitrile, and ZnCl₂:THF.

Additional curing agents are polyamides, polyamines, amidoamines, polyamidoamines, polycycloaliphatic, polyetheramide, imidazoles, dicyandiamide, substituted ureas and urones, hydrazines and silicones.

Urea based curing agents are the range of materials available under the commercial name DYHARD (marketed by Alzchem), and urea derivatives, such as the ones commercially available as UR200, UR300, UR400, UR600 and UR700. Urone accelerators include, for example, 4,4-methylene diphenylene bis(N,N-dimethyl urea) (available from Onmicure as U52 M).

When present, the total amount of curing agent is in the range of 1 wt % to 60 wt % of the resin composition. Typically, the curing agent is present in the range of 15 wt % to 50 wt %, more typically in the range of 20 wt % to 30 wt %.

Suitable toughening agents may include, but are not limited to, homopolymers or copolymers either alone or in combination of polyam ides, copolyamides, polyim ides, aramids, polyketones, polyetherimides (PEI), polyetherketones (PEK), polyetherketoneketone (PEKK), polyetheretherketones (PEEK), polyethersulfones (PES), polyetherethersulfones (PEES), polyesters, polyurethanes, polysulphones, polysulphides, polyphenylene oxide (PPO) and modified PPO, poly(ethylene oxide) (PEO) and polypropylene oxide, polystyrenes, polybutadienes, polyacrylates, polystyrene, polymethacrylates, polyacrylics, polyphenylsulfone, high performance hydrocarbon polymers, liquid crystal polymers, elastomers, segmented elastomers and core-shell particles.

Toughening particles or agents, when present, may be present in the range 0.1 wt % to 30 wt % of the resin composition. In an embodiment, the toughening particles or agents may be present in the range 10 wt % to 25 wt %. In another embodiment, the toughening particles or agents may be present in the range from 0.1 to 10 wt %. Suitable toughening particles or agents include, for example, Virantage VW10200 FRP, VW10300 FP and VW10700 FRP from Solvay, BASF Ultrason E2020 and Sumikaexcel 5003P from Sumitomo Chemicals.

The toughening particles or agents may be in the form of particles having a diameter larger than 20 microns, to prevent them from being incorporated into the fiber layers. The size of the toughening particles or agents may be selected such that they are not filtered by the fiber reinforcement. Optionally, the composition may also comprise inorganic ceramic particles, microspheres, micro-balloons and clays.

The resin composition may also contain conductive particles such as the ones described in PCT International Publications WO 2013/141916, WO 2015/130368 and WO 2016/048885.

The mold for resin infusion may be a two-component, closed mold or a vacuum bag sealed, single-sided mold. Following infusion of the matrix resin in the mold, the mold is heated to cure the resin.

During heating, the resin reacts with itself to form crosslinks in the matrix of the composite material. After an initial period of heating, the resin gels. Upon gelling, the resin no longer flows, but rather behaves as a solid. After gel, the temperature or cure may be ramped up to a final temperature to complete the cure. The final cure temperature depends on the nature and properties of the thermosetting resin chosen. Thus, in a suitable method, the composite material is heated to a first temperature suitable to gel the matrix resin, after which the temperature is ramped up to a second temperature and held for a time at the second temperature to complete the cure.

While applications of the inventive compositions, methods, and processes are described herein, other applications may be envisioned by those of ordinary skill in the art without departing from the spirit of the present disclosure. Such applications include, but are not limited to, fiber reinforced injection molding, pultrusion, ATL (automated tape laying), AFP (automated fiber placement), and additive manufacturing/3D printing.

The compositions, methods, and processes, including materials useful therefor, according to the present disclosure are further illustrated by the following non-limiting examples.

### EXAMPLES

### Example 1

### Preparation of Aqueous Polyamide-Amic Acid Composition Using Ammonium Hydroxide

Deionized water (2000-2500 mL) was charged to a 4-neck jacketed glass reactor fitted with overhead mechanical stirrer. Ammonium hydroxide solution (29% w/w) (100-150 grams) was added and the solution heated to 70° C. With vigorous agitation (400 rpm), polyamide-amic acid in the form a wet cake (30-40% solids content; 750-1000 grams) was added in a step-wise fashion over the course of about 10-15 minutes. After all the polymer was charged to the reactor, heating was continued for 1-2 hours. The polyamide-amic acid completely dissolved and an aqueous solution was obtained.

### Example 2

### Preparation of Aqueous Polyamide-Amic Acid Composition Using Ammonium Bicarbonate

Ammonium bicarbonate (119 g) was added to deionized water (3174 g) into a reaction vessel while stirring. Polyamide-amic acid in the form a wet cake (30-40% solids content; 591 g) was added to the ammonium bicarbonate solution under stirring. The resulting mixture was heated to about 75° C. under vigorous stirring for 4-7 hours. CO₂ gas evolution was observed with complete and efficient dissolution of the polyamide-amic acid. An aqueous solution was obtained.

Without wishing to be bound by theory, it is believed that the evolution of the CO₂ gas formed during the process drives the equilibrium towards formation of the ammonium salt, thus realizing the complete and efficient dissolution of the polyamide-amic acid.

### Example 3

### Formation of an Adherent Polyamide-Imide Film on Carbon Fiber

Carbon fiber was dip-coated with the aqueous polyamide-amic acid composition prepared according to Example 2. On drying at low temperatures (between 80° C. and 120° C.), the evolution of ammonia was observed. Ammonia ready dissociated and evolved to quickly and efficiently form a coating or size of the original polyamide-amic acid on the fiber surface in less than 2 minutes.

### Example 4

### Thermogravimetric Analysis (TGA) of Polyamide-Amic Acid Wet-Cake

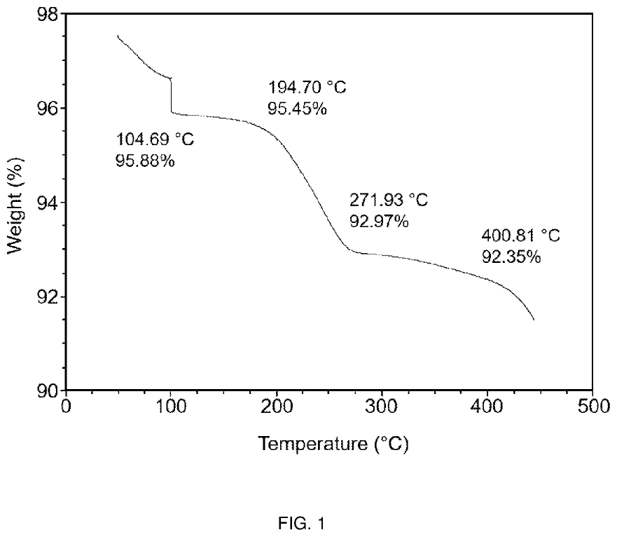

TGA was conducted on a polyamide-amic acid wet-cake. A graph of weight as a function of temperature of the polyamide-amic acid wet-cake is shown in FIG. 1.

As shown in FIG. 1, weight reduction due to the removal of solvent water occurred around 100° C. The corresponding imide was formed on further heating above 180° C. The nominal 1.5% weight loss between 195° C. and 275° C. is water loss during imide formation and is consistent with the acid number of the original polyamide-amic acid.

1. An aqueous polyamide-amic acid composition, comprising:
water; and
a polyamide-amic acid comprising recurring units each having at least one aromatic ring and at least one of an amic acid group and an imide group, wherein, in more than 50% mol of said recurring units that comprise at least one amic acid group, all or part of the amic acid groups are in salified form in which the cation is an ammonium cation.

2. The aqueous polyamide-amic acid composition according to claim 1, further comprising an organic solvent, wherein the total amount of the organic solvent is less than 20% by weight with respect to the weight of the polyamide-amic acid.

3. The aqueous polyamide-amic acid composition according to claim 1, wherein the recurring units are each selected from the group consisting of: 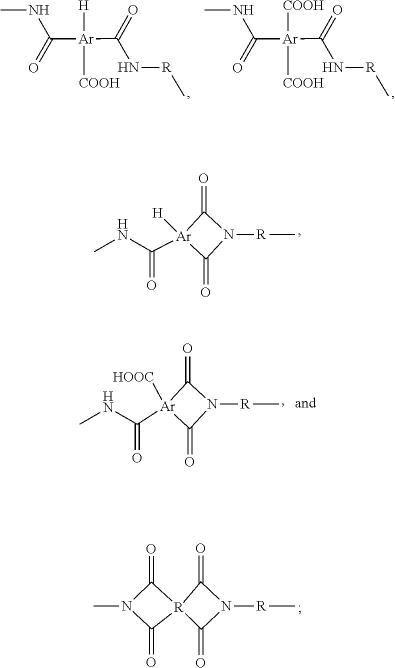
wherein
Ar is 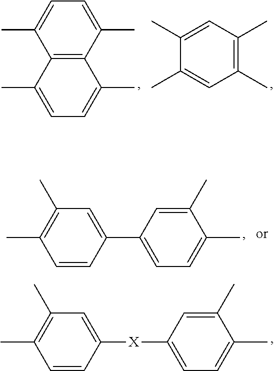
wherein X is 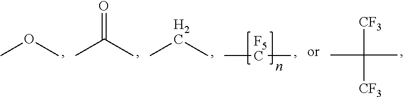
wherein n is 0, 1, 2, 3, 4, or 5;
R is 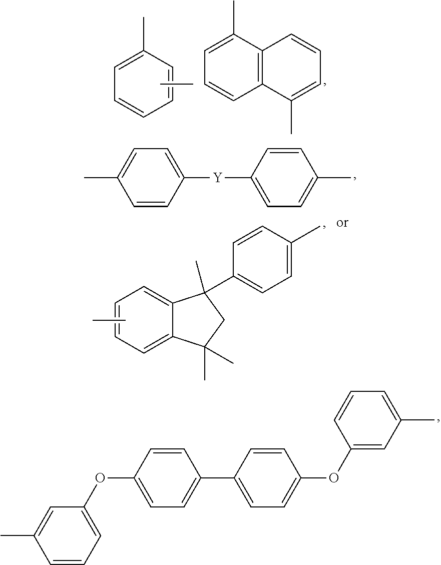
wherein Y is 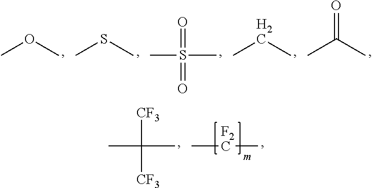
wherein m is 0, 1, 2, 3, 4, or 5.

4. The aqueous polyamide-amic acid composition according to claim 3, wherein the recurring units are each selected from the group consisting of:

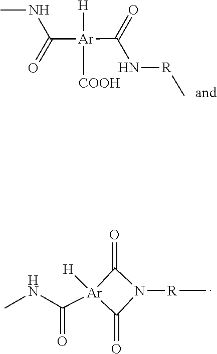

5. The aqueous polyamide-amic acid composition according to claim 3, wherein Ar is

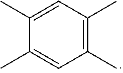

6. The aqueous polyamide-amic acid composition according to claim 3, wherein R is 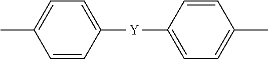
and Y is as defined.

7. The aqueous polyamide-amic acid composition according to claim 1, wherein the aqueous polyamide-amic acid composition is free of tertiary amines, typically tertiary alkylamines, and salts thereof.

8. The aqueous polyamide-amic acid composition according to claim 1, wherein the aqueous polyamide-amic acid composition comprises an amount of water sufficient to provide a polyamide-amic acid content of from about 0.5 to about 15 wt. %, based on the total weight of the composition.

9. A process for forming an aqueous polyamide-amic acid composition according to claim 1, the process comprising:
reacting, in an aqueous medium, a polyamide-amic acid comprising recurring units each having at least one aromatic ring and at least one of an amic acid group and an imide group with an ammonium salt.

10. The process according to claim 9, wherein, in more than 50% mol of said recurring units that comprise at least one amic acid group, all or part of the amic acid groups are converted to salified form in which the cation is an ammonium cation.

11. The process according to claim 9, wherein the ammonium salt comprises an ammonium cation and an anion that is the conjugate base of a weak acid.

12. The process according to claim 9, wherein the ammonium salt comprises an ammonium cation and an anion selected from the group consisting of hydroxide, oxalate, carbonate, bicarbonate, sulfite, hydrogen sulfite, sulfate, hydrogen sulfate, dihydrogen phosphate, hydrogen phosphate, phosphate, nitrite, carboxylate, such as acetate, propanoate, butanoate; perchlorate, chlorate, chlorite, and hypochlorite.

13. The process according to claim 9, wherein the ammonium salt comprises an ammonium cation and an anion selected from the group consisting of hydroxide and bicarbonate, typically bicarbonate.

14. A method for providing an adherent polyamide-imide film to at least one surface of a substrate, the method comprising:
coating the said surface with the aqueous polyamide-amic acid composition according to claim 1 or the aqueous polyamide-amic acid composition obtained according to a process for forming an aqueous polyamide-amic acid composition, the process comprising reacting, in an aqueous medium, a polyamide-amic acid comprising recurring units each having at least one aromatic ring and at least one of an amic acid group and an imide group with an ammonium salt,
heating the wet coating at a first temperature, thereby providing a dried coating comprising the polyamide-amic acid free of ammonium cation,
heating the said article at a second temperature to cure the dried coating, thereby providing the adherent polyamide-imide film on the at least one surface.

15. A film comprising the ammonium salt of a polyamide-amic acid, said film prepared from the aqueous polyamide-amic acid composition according to claim 1.

16. An article of manufacture comprising the film of claim 15.

17. One or more fibers comprising the film of claim 15.

18. The one or more fibers according to claim 17, wherein the one or more fibers are carbon fibers.

19. One or more heat-treated fibers formed by heating the one or more fibers according to claim 17.

20. A composite material comprising the one or more fibers according to claim 19, and a thermoset matrix resin.
